(19) United States
(12) Patent Application Publication
(10) Pub. No.: US 2026/0001027 A1
(43) Pub. Date: Jan. 1, 2026

(54) ACID GAS CAPTURE SYSTEM AND ACID GAS CAPTURE METHOD

(71) Applicant: NGK INSULATORS, LTD., Nagoya-City (JP)

(72) Inventors: Junichi ANDO, Nagoya-Shi (JP); Yusuke OKUMA, Gifu-Shi (JP); Kazuki IIDA, Nagoya-Shi (JP); Michio TAKAHASHI, Nagoya-Shi (JP); Hirofumi KAN, Nagoya-Shi (JP)

(73) Assignee: NGK INSULATORS, LTD., Nagoya-City (JP)

(21) Appl. No.: 19/322,804

(22) Filed: Sep. 9, 2025

Related U.S. Application Data
(63) Continuation of application No. PCT/JP2024/013064, filed on Mar. 29, 2024.

(30) Foreign Application Priority Data
Apr. 12, 2023 (JP) 2023-064972

(51) Int. Cl. B01D 53/04

(52) U.S. Cl. CPC B01D 53/0438; B01D 2253/3425; B01D 2257/504; B01D 2258/06; B01D 2259/40088

(57) ABSTRACT

An acid gas capture system includes: an acid gas adsorption part including an acid gas adsorption material capable of adsorbing an acid gas contained in a gas to be treated and capable of desorbing the adsorbed acid gas; a housing part, which includes a flow passage to which the gas to be treated is to be supplied, and which is configured to house the acid gas adsorption part so that the acid gas adsorption material is positioned in the flow passage; a heating medium supply part capable of supplying a heating medium having a pressure above an atmospheric pressure to the flow passage; and a capture part capable of capturing a captured gas containing the heating medium having passed through the acid gas adsorption part and the acid gas desorbed from the acid gas adsorption material, from the housing part.

### CROSS-REFERENCE TO RELATED APPLICATIONS

This application is a continuation under 35 U.S.C. 120 of International Application PCT/JP2024/013064 having the International Filing Date of Mar. 29, 2024 and having the benefit of the earlier filing date of Japanese Application No. 2023-064972 filed on Apr. 12, 2023. Each of the identified applications is fully incorporated herein by reference.

### BACKGROUND OF THE INVENTION

### 1. Field of the Invention

The present disclosure relates to an acid gas capture system and an acid gas capture method.

### 2. Description of the Related Art

In recent years, an attempt has been made to separate and capture an acid gas, such as carbon dioxide (hereinafter sometimes referred to as “CO₂”), from the atmosphere in order to reduce an environmental load. As an acid gas capture device to be used for separation and capture of an acid gas, there has been proposed a gas separation unit including a gas adsorption part having a pellet structure (see, for example, Patent Literature 1). In such an acid gas capture device, an adsorption step of causing an acid gas adsorption material to adsorb an acid gas to separate the acid gas from the atmosphere, and a desorption step of heating a gas adsorption part to a predetermined desorption temperature to cause the acid gas adsorption material to desorb the acid gas, are performed in the stated order, to thereby capture the acid gas.

In such a desorption step, in general, the acid gas is sucked to be captured by reducing the pressure below the atmospheric pressure. However, there is a problem in that the heating efficiency of the gas adsorption part is decreased under reduced pressure, and the energy required for desorbing the acid gas is increased.

### CITATION LIST

### Patent Literature

[PTL 1] WO 2014/170184 A1

### SUMMARY OF THE INVENTION

A primary object of the present disclosure is to provide an acid gas capture system and an acid gas capture method that enable capturing an acid gas with less energy.
[1] According to an embodiment of the present disclosure, there is provided an acid gas capture system, including an acid gas adsorption part, a housing part, a heating medium supply part, and a capture part. The acid gas adsorption part includes an acid gas adsorption material. The acid gas adsorption material is capable of adsorbing an acid gas contained in a gas to be treated and is capable of desorbing the adsorbed acid gas. The housing part includes a flow passage to which the gas to be treated is to be supplied. The housing part is configured to house the acid gas adsorption part so that the acid gas adsorption part is positioned in the flow passage. The heating medium supply part is capable of supplying a heating medium having a pressure above the atmospheric pressure to the flow passage. The capture part is capable of capturing a captured gas from the housing part. The captured gas contains the heating medium having passed through the acid gas adsorption part and the acid gas desorbed from the acid gas adsorption material.
[2] In the acid gas capture system according to the above-mentioned item [1], a temperature difference specific heat coefficient ΔCp/ΔT of the heating medium may be set so as to satisfy the following formula (1):

$$Δ Cp / Δ T \leq 0.039 ( J / ( mol \cdot {K}^{2} ) ) \qquad ( 1 )$$

ΔCp: a difference between a constant pressure molar specific heat “a” of the supplied heating medium at an inlet of the flow passage and a constant pressure molar specific heat “b” of the captured gas discharged from the flow passage (constant pressure molar specific heat “a”−constant pressure molar specific heat “b”) (unit: J/(mol·K)),
ΔT: a difference between a temperature “a” of the supplied heating medium at the inlet of the flow passage and a temperature “b” of the captured gas discharged from the flow passage (gas temperature “a”−gas temperature “b”) (unit: K).
[3] In the acid gas capture system according to the above-mentioned item [1] or [2], the heating medium supply part may include a pressurizing device capable of pressurizing the heating medium.
[4] In the acid gas capture system according to any one of the above-mentioned items [1] to [3], the capture part may include a storage tank capable of storing the captured gas.
[5] The acid gas capture system according to the above-mentioned item [4] may further include a return part. The return part is capable of returning at least part of the captured gas stored in the storage tank, as the heating medium from the storage tank to the heating medium supply part.
[6] In the acid gas capture system according to the above-mentioned item [4] or [5], the storage tank may be capable of separating part of the heating medium from the captured gas.
[7] The acid gas capture system according to any one of items [1] to [6], the acid gas may be carbon dioxide.
[8] According to another aspect of the present disclosure, there is provided an acid gas capture method, including an adsorption step and a desorption step. In the adsorption step, a gas to be treated containing an acid gas is suppled to a flow passage of a housing part in which an acid gas adsorption part including an acid gas adsorption material is arranged, to cause the acid gas adsorption material to adsorb the acid gas. In the desorption step, a heating medium having a pressure above an atmospheric pressure is supplied to the flow passage, and the acid gas adsorption part is heated to a predetermined desorption temperature to cause the acid gas adsorption material to desorb the acid gas. In the desorption step, a captured gas containing the heating medium having passed through the acid gas adsorption part and the acid gas desorbed from the acid gas adsorption material is captured from the flow passage.
[9] In the acid gas capture method according to the above-mentioned item [8], in the desorption step, a temperature difference specific heat coefficient ΔCp/ΔT of the heating medium may satisfy the above-mentioned formula (1).

According to the embodiment of the present disclosure, the acid gas can be captured with less energy.

### BRIEF DESCRIPTION OF THE DRAWINGS

FIG. 1A is a schematic configuration view of an acid gas capture system according to one embodiment of the present disclosure.

FIG. 1B is a schematic configuration view of an acid gas capture system according to another embodiment of the present disclosure.

FIG. 2 is a schematic configuration view of an acid gas adsorption part of the acid gas capture system of FIG. 1A.

FIG. 3 is a schematic perspective view of an acid gas adsorption part of an acid gas capture system according to still another embodiment of the present disclosure.

FIG. 4 is a longitudinal sectional view of the acid gas adsorption part of FIG. 3 taken along the center.

### DESCRIPTION OF THE EMBODIMENTS

Embodiments of the present disclosure are described below with reference to the drawings. However, the present disclosure is not limited to these embodiments. For clearer illustration, some widths, thicknesses, shapes, and the like of respective portions may be schematically illustrated in the drawings in comparison to the embodiments. However, the widths, the thicknesses, the shapes, and the like are merely an example, and do not limit understanding of the present disclosure.

### A. Overview of Acid Gas Capture System

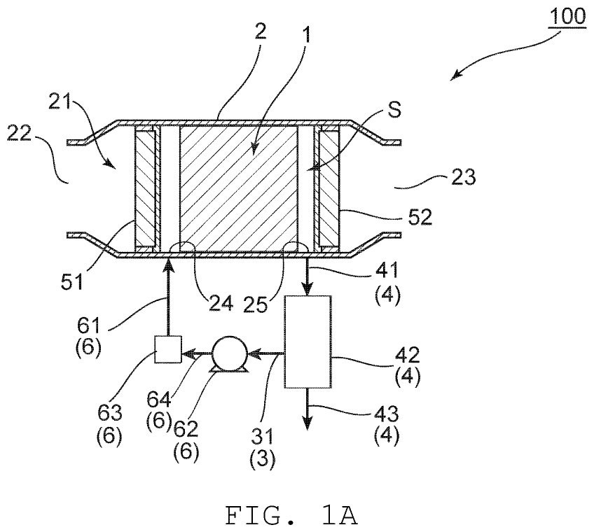

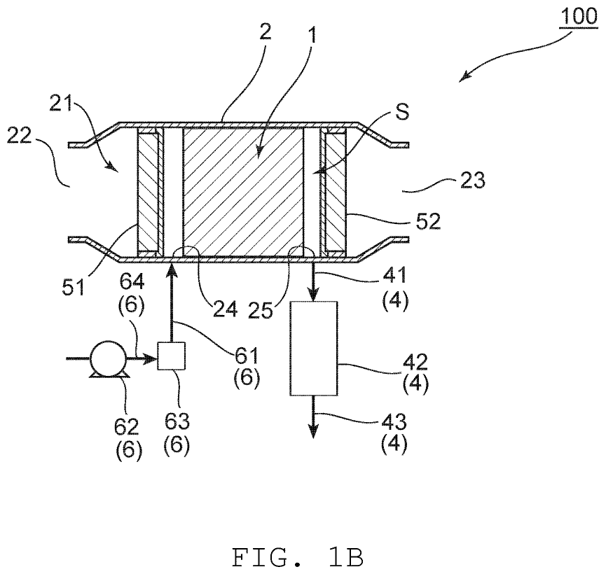

FIG. 1A is a schematic configuration view of an acid gas capture system according to one embodiment of the present disclosure. FIG. 1B is a schematic configuration view of an acid gas capture system according to another embodiment of the present disclosure.

An acid gas capture system 100 of the illustrated example includes an acid gas adsorption part 1, a housing part 2, a heating medium supply part 6, and a capture part 4. The acid gas adsorption part 1 includes an acid gas adsorption material. The acid gas adsorption material can adsorb an acid gas contained in a gas to be treated, and can desorb the adsorbed acid gas. The housing part 2 includes a flow passage 21 to which the gas to be treated is to be supplied. In the illustrated example, the housing part 2 has a tubular shape extending in a supply direction of the gas to be treated. The housing part 2 houses the acid gas adsorption part 1 so that the acid gas adsorption part 1 is positioned in the flow passage 21. The heating medium supply part 6 can supply a heating medium having a pressure above the atmospheric pressure (0.1 MPaA (absolute pressure)) to the flow passage 21. The capture part 4 can capture a captured gas from the housing part 2. The captured gas contains the heating medium having passed through the acid gas adsorption part 1 and the acid gas desorbed from the acid gas desorption material.

With such a configuration, the acid gas capture system can perform an adsorption step and a desorption step in the stated order, and can capture an acid gas in a pressurized state. Specifically, when the gas to be treated containing the acid gas is supplied to the flow passage of the housing part, the acid gas adsorption material in the acid gas adsorption part positioned in the flow passage can adsorb the acid gas. After that, the heating medium supply part can supply the heating medium having a pressure above the atmospheric pressure (0.1 MPaA) to the flow passage. Then, under a pressure above the atmospheric pressure, the acid gas adsorption part is efficiently heated to a predetermined desorption temperature by the heating medium, and as a result, the acid gas adsorption material is efficiently heated. Thus, the acid gas can be desorbed from the acid gas adsorption material. Accordingly, the energy required for desorbing the acid gas can be significantly suppressed.

In addition, the capture part can capture the captured gas containing the heating medium having passed through the acid gas adsorption part and the acid gas desorbed from the acid gas adsorption material, from the housing part. As a result, the acid gas can be captured together with the heating medium with less energy. The captured gas contains the heating medium supplied under a state of having a pressure above the atmospheric pressure and hence is pressurized above the atmospheric pressure (0.1 MPaA). In other words, the capture part can capture the acid gas in a pressurized state (in other words, in a state of having a pressure above the atmospheric pressure) together with the heating medium. Such an acid gas is in a pressurized state, and hence can be supplied to various devices with excellent energy efficiency and effectively utilized with less energy.

In one embodiment, the housing part 2 includes a first inflow port 22, a first outflow port 23, a second inflow port 24, and a second outflow port 25.

The first inflow port 22 is positioned in an upstream end portion in the supply direction of the gas to be treated in the housing part 2. The first inflow port 22 allows passage of the gas to be treated in the adsorption step.

The first outflow port 23 is positioned in a downstream end portion in the supply direction of the gas to be treated in the housing part 2. The first outflow port 23 allows passage of the treated gas having the acid gas concentration reduced after passing through the acid gas adsorption part 1 in the adsorption step.

The second inflow port 24 and the second outflow port 25 are positioned between the first inflow port 22 and the first outflow port 23. The second inflow port 24 and the second outflow port 25 are each typically formed in the side wall of the housing part 2. The second inflow port 24 allows passage of the heating medium in the desorption step. The second outflow port 25 allows passage of the captured gas in the desorption step.

In one embodiment, the acid gas capture system 100 further includes a first valve 51 and a second valve 52. Each of the first valve 51 and the second valve 52 can open and close the flow passage 21. The first valve 51 is positioned on an upstream side of the acid gas adsorption part 1 in the supply direction of the gas to be treated. The second valve 52 is positioned on a side opposite to the first valve 51 with respect to the acid gas adsorption part 1. When the first valve 51 and the second valve 52 are in a closed state, the first valve 51 and the second valve 52 partition the flow passage 21 to define a housing space S in which the acid gas adsorption part 1 is positioned. Each of the second inflow port 24 and the second outflow port 25 is positioned between the first valve 51 and the second valve 52. The heating medium supply part 6 can supply the heating medium in a pressurized state to the housing space S through the second inflow port 24.

With such a configuration, in the desorption step, when the heating medium supply part supplies the heating medium in a pressurized state to the housing space under a condition that the first valve and the second valve are in a closed state, the housing space can be sufficiently increased in pressure. Thus, the capture part can stably capture the sufficiently pressurized captured gas through the second outflow port.

Examples of the first valve 51 include a ball valve, a gate valve, and a butterfly valve. The first valve 51 is preferably a butterfly valve. The second valve 52 is described in the same manner as in the first valve 51.

The configuration of the heating medium supply part 6 is not particularly limited as long as the heating medium having a pressure above the atmospheric pressure can be supplied to the flow passage 21. The pressure of the heating medium may be suitably and appropriately adjusted so that the pressure of the flow passage 21 (typically, the housing space S) to which the heating medium is supplied falls within a range described later.

In one embodiment, the heating medium supply part 6 includes a pressurizing device 62 that can pressurize the heating medium. When the heating medium supply part includes the pressurizing device, the heating medium can be stably pressurized to a desired pressure.

The pressurizing device 62 can typically pump the heating medium. The pressurizing device 62 has any appropriate configuration. Examples of the pressurizing device 62 include a fan, a blower, and a compressor.

The heating medium supply part 6 in the illustrated example includes a heating device 63, a connection line 64, and a supply line 61 in addition to the pressurizing device 62.

The heating device 63 can typically heat the heating medium. In the illustrated example, the heating medium pressurized by the pressurizing device 62 is supplied to the heating device 63. The heating device 63 has any appropriately configuration. Examples of the heating device 63 include a heater and a heat exchanger.

The connection line 64 is typically a pipe that can supply the heating medium pressurized by the pressurizing device 62 to the heating device 63. An upstream end portion in a supply direction of the heating medium in the connection line 64 is connected to the pressurizing device 62. A downstream end portion in the supply direction of the heating medium in the connection line 64 is connected to the heating device 63.

The supply line 61 is typically a pipe that allows passage of the heated and pressurized heating medium. An upstream end portion in a passage direction of the heating medium in the supply line 61 is connected to the heating device 63. A downstream end portion in the passage direction of the heating medium in the supply line 61 is connected to a side wall of the housing part 2 so as to be in communication with the second inflow port 24. As a result, the heating medium supply part can stably supply the heating medium in a pressurized state to the housing space of the housing part.

In one embodiment, the capture part 4 includes a storage tank 42. The storage tank 42 can typically store the captured gas in a pressurized state.

The storage tank 42 may have any appropriate configuration. The storage tank 42 is typically configured so as to be able to separate part of the heating medium from the captured gas to be stored. In the storage tank 42 in the illustrated example, the inside of the storage tank 42 is pressurized above the atmospheric pressure (0.1 MPaA), and hence part of the heating medium can be drained (liquefied). As a result, part of the drained heating medium is accumulated in a bottom portion of the storage tank 42. Thus, the self-pressure of the captured gas can be effectively utilized for partial separation of the heating medium.

The capture part 4 in the illustrated example includes a capture line 41 and a discharge line 43 in addition to the storage tank 42.

The capture line 41 is typically a pipe that allows passage of the captured gas discharged from the second outflow port 25. An upstream end portion in a passage direction of the captured gas in the capture line 41 is connected to the side wall of the housing part 2 so as to be in communication with the second outflow port 25. A downstream end portion in the passage direction of the captured gas in the capture line 41 is connected to the storage tank 42. Although not shown, the capture line 41 may be provided with a valve that can adjust the flow rate of the captured gas. With this configuration, in the desorption step, the internal pressure of the housing space can be suitably adjusted, and as a result, a captured gas having a desired pressure can be captured.

The discharge line 43 is typically a pipe that can discharge part of the heating medium separated in the storage tank 42. An upstream end portion in a discharge direction of the captured gas in the discharge line 43 is connected to the bottom portion of the storage tank 42. As a result, impurities can be removed from the acid gas capture system.

As illustrated in FIG. 1A, in one embodiment, the acid gas capture system 100 further includes a return part 3.

The return part 3 can return at least part of the captured gas stored in the storage tank 42, as the heating medium from the storage tank 42 to the heating medium supply part 6. Thus, the self-pressure of the captured gas can be effectively utilized for pressurizing the heating medium in the heating medium supply part. As a result, the energy required for driving the pressurizing device 62 can be reduced, or a heating medium having a pressure above the atmospheric pressure can be supplied to the flow passage without using the pressurizing device 62. Thus, the acid gas capture system 100 can be operated with less energy.

In the illustrated example, the return part 3 can return at least part of the captured gas as the heating medium from the storage tank 42 to the pressurizing device 62. The return part 3 typically includes a return line 31.

The return line 31 is typically a pipe that allows passage of the captured gas returned as the heating medium. In the illustrated example, an upstream end portion in a return direction of the captured gas in the return line 31 is connected to the storage tank 42. A downstream end portion in the return direction of the captured gas in the return line 31 is connected to the pressurizing device 62.

In FIG. 1A, the storage tank 42 is connected to the pressurizing device 62 as a supply source of the heating medium through the return line 31, but the acid gas capture system 100 is not limited thereto. The acid gas capture system 100 illustrated in FIG. 1B does not include the return part 3. In this case, the captured gas is not returned from the storage tank 42 to the pressurizing device 62, and the heating medium is supplied from a supply source other than the storage tank 42.

Further, although not shown, the acid gas capture system 100 may also be configured without the pressurizing device 62. In this case, typically, a heating medium (for example, water vapor) having a self-pressure above the atmospheric pressure is supplied to the heating device 63. As a result, the acid gas capture system can be simplified.

Examples of the acid gas contained in the gas to be treated of the acid gas capture system include carbon dioxide (CO₂), hydrogen sulfide, sulfur dioxide, nitrogen dioxide, dimethyl sulfide (DMS), and hydrogen chloride. In one embodiment, the acid gas is carbon dioxide (CO₂), and the gas to be treated is a CO₂-containing gas. The CO₂-containing gas may also contain nitrogen in addition to CO₂. The CO₂-containing gas is typically air (atmosphere). The CO₂ concentration in the CO₂-containing gas before being supplied to the acid gas capture system is, for example, 100 ppm (on a volume basis) or more and 2 vol % or less.

Examples of the heating medium supplied by the heating medium supply portion include water vapor and CO₂. The heating media may be used alone or in combination thereof. When the acidic gas is CO₂, the heating medium is preferably CO₂.

Now, description is given in detail of a case in which the acid gas and the heating medium are each carbon dioxide (CO₂).

When the acid gas is CO₂, the acid gas adsorption material included in the acid gas adsorption part is a carbon dioxide adsorption material.

Any appropriate compound capable of adsorbing and desorbing CO₂ may be adopted as the carbon dioxide adsorption material. Examples of the carbon dioxide adsorption material include: nitrogen-containing compounds; alkali compounds, such as sodium hydroxide and potassium hydroxide; carbonate salts, such as calcium carbonate and potassium carbonate; hydrogen carbonate salts, such as calcium hydrogen carbonate and potassium hydrogen carbonate; metal organic frameworks (MOF), such as MOF-74, MOF-200,and MOF-210; ionic liquids; deep eutectic solvents; oxides, such as cerium oxide and iron oxide; zeolite; activated carbon; and nitrogen-doped carbon. Those carbon dioxide adsorption materials may be used alone or in combination thereof.

Of such carbon dioxide adsorption materials, a nitrogen-containing compound and an ionic liquid are preferred.

More specific examples of the nitrogen-containing compound include: primary amines, such as monoethanolamine and polyvinylamine; secondary amines, such as diethanolamine, a cyclic amine, and N-(3-aminopropyl)diethanolamine; tertiary amines, such as methyldiethylamine and triethanolamine; ethyleneamine compounds such as tetraethylenepentamine; aminosilane coupling agents, such as aminopropyltrimethoxysilane, 3-aminopropyltriethoxysilane, N-(2-aminoethyl)-3-aminopropyl-trimethoxysilane, and polyethyleneimine-trimethoxysilane; ethyleneimine; linear polyethyleneimines; branched polyethyleneimines each having a primary amino group to a tertiary amino group; piperazine compounds such as 1-(2-hydroxyethyl)piperazine; polyamidoamine; polyvinylamine; and organic/inorganic compounds each having an amino group added as a substituent thereto.

Of the carbon dioxide adsorption materials, methyldiethylamine, monoethanolamine, a cyclic amine, diethanolamine, tetraethylenepentamine, ethyleneimine, a linear polyethyleneimine, a branched polyethyleneimine, and an organic/inorganic compound having an amino group added as a substituent thereto are preferred.

Such nitrogen-containing compounds may be used alone or in combination thereof.

The ionic liquid is a “salt” of a liquid formed only of an ion (an anion or a cation), and is in a liquid state under normal temperature and normal pressure (23° C., 0.1 MPa). Examples of the cation of the ionic liquid include: an ammonium-based ion, such as an imidazolium salt or a pyridinium salt; a phosphonium-based ion; a sulfonium salt; and an inorganic-based ion. Examples of the anion of the ionic liquid include: a halogen-based ion, such as a bromide ion or a triflate ion; a boron-based ion such as a tetraphenylborate ion; a phosphorus-based ion such as a hexafluorophosphate ion; and a sulfur-based ion such as an alkyl sulfonate ion. Of the ionic liquids, a combination of an imidazolium salt serving as a cation and a triflate ion serving as an anion is preferred.

The ionic liquid is more preferably used in combination with a carbon dioxide adsorption material other than the ionic liquid (hereinafter referred to as “another carbon dioxide adsorption material”). In this case, the ionic liquid is applied to another carbon dioxide adsorption material (for example, a nitrogen-containing compound). Thus, the performance of the carbon dioxide adsorption material can be improved, and the lifetime thereof can be extended.

The content ratio of the ionic liquid is, for example, 0.000001 part by mass or more, preferably 0.00001 part by mass or more with respect to 1 part by mass of another carbon dioxide adsorption material. Meanwhile, the content ratio of the ionic liquid is, for example, 0.1 part by mass or less, preferably 0.05 part by mass or less with respect to 1 part by mass of another carbon dioxide adsorption material. When the content ratio of the ionic liquid falls within the above-mentioned ranges, the performance of the carbon dioxide adsorption material can be stably improved, and the lifetime thereof can be stably extended.

A specific configuration of the acid gas adsorption part is described below.

### B. Acid Gas Adsorption Part

### B-1. First Embodiment of Acid Gas Adsorption Device

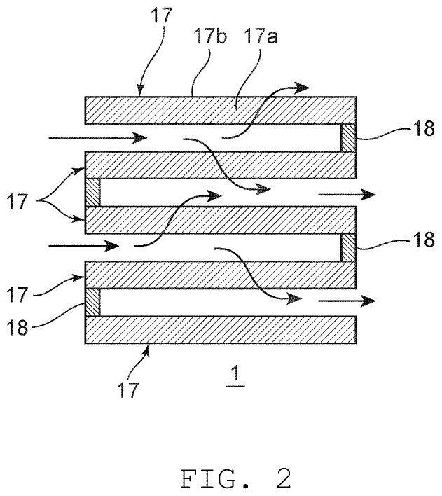

In one embodiment, as illustrated in FIG. 2, the acid gas adsorption part 1 includes a plurality of adsorption parts 17.

The plurality of adsorption parts 17 are stacked in a thickness direction thereof so as to be spaced apart from each other. A flow passage is formed between adjacent adsorption parts 17 among the plurality of adsorption parts 17. In the illustrated example, five adsorption parts 17 are arranged in parallel. However, the number of the adsorption parts 17 is not limited thereto. The number of the adsorption parts 17 is, for example, 5 or more, preferably 10 or more, more preferably 20 or more. A distance between adjacent adsorption parts 17 among the plurality of adsorption parts 17 is, for example, 0.5 cm or more and 1.5 cm or less.

Each of the plurality of adsorption parts 17 includes a plurality of pellet-like adsorption materials 17a and a flexible fiber member 17b.

The pellet-like adsorption material 17a serves as an acid gas adsorption material, and typically serves as a carbon dioxide adsorption material. Examples of a material for the pellet-like adsorption material 17a include a material modified with the above-mentioned acid gas adsorption material, preferably cellulose modified with the above-mentioned acid gas adsorption material, more preferably nanofibrillated cellulose modified with the above-mentioned acid gas adsorption material. A mean primary particle diameter of the pellet-like adsorption material 17a is, for example, 60 μm or more and 1,200 μm or less. Any appropriate value may be used as a filling ratio of the pellet-like adsorption materials 17a in the adsorption parts 17.

The flexible fiber member 17b is typically formed in a hollow shape (bag shape) that allows the plurality of pellet-like adsorption materials 17a to be housed therein. The flexible fiber member 17b allows passage of a gas and regulates passage of the pellet-like adsorption material. The flexible fiber member 17b may be a fabric or a non-woven fabric. Examples of a material for the flexible fiber member 17b include organic fibers and natural fibers, preferably, a polyethylene terephthalate fiber, a polyethylene fiber, and a cellulose-based fiber. A thickness of the flexible fiber member 17b is, for example, 25 μm or more and 500 μm or less.

The acid gas adsorption part 1 of the illustrated example further includes a plurality of spacers 18. The spacer 18 is located between adjacent adsorption parts 17 among the plurality of adsorption parts 17. With this configuration, a distance between adjacent adsorption material layers among the adsorption material layers can be stably ensured. In one embodiment, the plurality of adsorption parts 17 and the plurality of spacers 18 are arranged in a substantially zig-zag pattern when viewed from a direction (depth direction on the drawing sheet of each of FIG. 1A and FIG. 1B) orthogonal to the thickness direction of the adsorption parts 17.

As the acid gas adsorption part 1 as described above, there is, for example, a gas separation unit as described in WO 2014/170184 A1. The publication is incorporated herein in its entirety by reference.

### B-2. Second Embodiment of Gas Adsorption Device

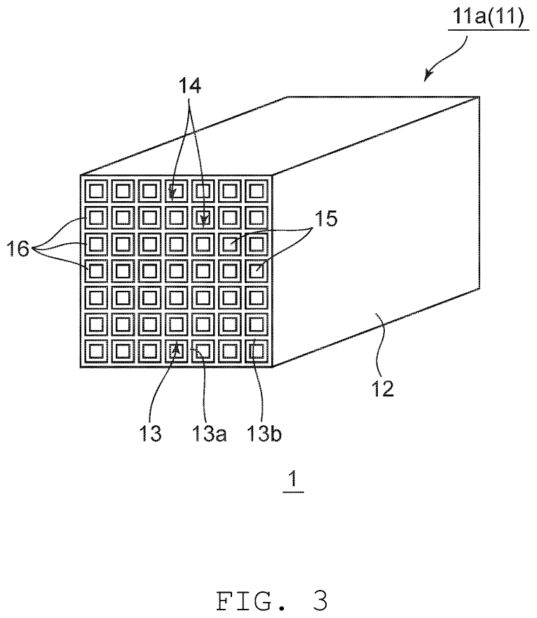

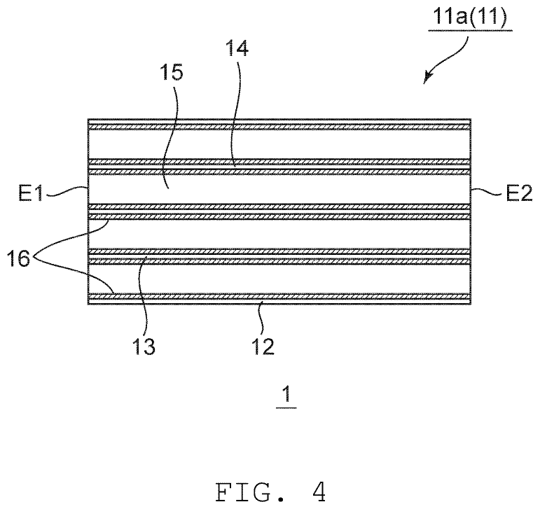

In another embodiment, as illustrated in FIG. 3 and FIG. 4, the acid gas adsorption part 1 includes a base material 11 and acid gas adsorption material layers 16.

The structure of the base material 11 is not particularly limited, and is, for example, a honeycomb-like structure, a filter structure such as a filtration cloth, or a pellet structure. The acid gas adsorption material layer 16 is not particularly limited as long as the layer is arranged on the surface of any such base material 11.

### B-2-1. Honeycomb-Like Base Material

In one embodiment, the base material 11 is a honeycomb-like base material 11a. The honeycomb-like base material 11a includes partition walls 13 that define a plurality of cells 14.

The cells 14 each extend from a first end surface E1 (inflow end surface) of the honeycomb-like base material 11a to a second end surface E2 (outflow end surface) thereof in i the lengthwise direction (axial direction) of the honeycomb-like base material 11a (see FIG. 4). The cells 14 each have any appropriate shape in a cross section in a direction perpendicular to the lengthwise direction of the honeycomb-like base material 11a. The sectional shapes of the cells are each, for example, a triangle, a quadrangle, a pentagon, a hexagon, a higher polygon, a circle, or an ellipse. The sectional shapes and sizes of the cells may be all the same, or may be at least partly different. Of such sectional shapes of the cells, for example, a hexagon or a quadrangle is preferred, and a square, a rectangle, or a hexagon is more preferred.

A cell density in a cross section in the direction perpendicular to the lengthwise direction of the honeycomb-like base material (specifically, the number of cells 14 per unit area) may be appropriately set in accordance with purposes. The cell density may be, for example, from 4 cells/cm² to 320 cells/cm². When the cell density falls within such a range, the strength and effective geometric surface area (GSA) of the honeycomb-like base material can be sufficiently ensured.

The honeycomb-like base material 11a has any appropriate shape (overall shape). The shape of the honeycomb-like base material is, for example, a cylinder with a circle as its bottom, an elliptic cylinder with an ellipse as its bottom, a prismatic column with a polygon as its bottom, or a column with an indefinite shape as its bottom. The honeycomb-like base material 11a of the illustrated example has a prismatic columnar shape. The outer diameter and length of the honeycomb-like base material may be appropriately set in accordance with purposes. The honeycomb-like base material may have a hollow region in a center portion thereof in the cross section in the direction perpendicular to the lengthwise direction, though the hollow region is not shown.

The honeycomb-like base material 11a typically includes: an outer wall 12; and a partition wall 13 positioned inside the outer wall 12. In the illustrated example, the outer wall 12 and the partition wall 13 are integrally formed. The outer wall 12 and the partition wall 13 may be separate bodies.

In the illustrated example, the outer wall 12 has a rectangular cylindrical shape. The thickness of the outer wall 12 may be set to any appropriate thickness. The thickness of the outer wall 12 is, for example, from 0.1 mm to 10 mm.

The partition wall 13 defines the plurality of cells 14. More specifically, the partition wall 13 has a first partition wall 13a and a second partition wall 13b perpendicular to each other, and the first partition wall 13a and the second partition wall 13b define the plurality of cells 14. The sectional shapes of the cells 14 are each a substantially quadrangular shape. The configuration of the partition wall is not limited to the partition wall 13 described above. The partition wall may have a first partition wall extending in a radial direction and a second partition wall extending in a circumferential direction, which define a plurality of cells.

The thickness of the partition wall: 13 may be appropriately set in accordance with the applications of the acid gas adsorption device. The thickness of the partition wall 13 is typically smaller than the thickness of the outer wall 12. The thickness of the partition wall 13 is, for example, from 0.03 mm to 0.6 mm. The thickness of the partition wall is measured, for example, through sectional observation with a scanning electron microscope (SEM). When the thickness of the partition wall falls within such a range, the honeycomb-like base material can achieve sufficient mechanical strength, and can also achieve a sufficient opening area (total area of the cells in a cross section).

The porosity of the partition wall 13 may be appropriately set in accordance with purposes. The porosity of the partition wall 13 is, for example, 15% or more, preferably 20% or more. Meanwhile, the porosity of the partition wall 13 is, for example, 70% or less, preferably 45% or less. The porosity may be measured, for example, by mercury porosimetry.

The bulk density of the partition wall 13 may be appropriately set in accordance with purposes. The bulk density of the partition wall 13 is, for example, 0.10 g/cm³ or more, preferably 0.20 g/cm³ or more. Meanwhile, the bulk density of the partition wall 13 is, for example, 0.60 g/cm³ or less, preferably 0.50 g/cm³ or less. The bulk density may be measured, for example, by mercury porosimetry.

A material for forming the partition wall 13 is typically, for example, a ceramic. Examples of the ceramic include silicon carbide, a silicon-silicon carbide-based composite material, cordierite, mullite, alumina, silicon nitride, spinel, a silicon carbide-cordierite-based composite material, lithium aluminum silicate, and aluminum titanate. Those materials for forming the partition walls may be used alone or in combination thereof. Of those materials for forming the partition walls, for example, cordierite, alumina, mullite, silicon carbide, a silicon-silicon carbide-based composite material, and silicon nitride are preferred, and silicon carbide and a silicon-silicon carbide-based composite material are more preferred.

Such a honeycomb-like base material 11a is typically produced by the following method. First, a binder and water or an organic solvent are added to material powder including ceramic powder described above as required. The resultant mixture is kneaded to provide a body, and the body is molded (typically extruded) into a desired shape. After that, the body is dried, and is fired as required. Thus, the honeycomb-like base material 11a is produced. When the firing is adopted, the body is fired at, for example, from 1,200° C. to 1,500° C. A firing time period is, for example, 1 hour or more and 20 hours or less.

### B-2-2. Acid Gas Adsorption Layer (Carbon Dioxide Adsorption Layer)

In one embodiment, the acid gas adsorption material layer 16 is formed on the surface of the partition wall 13 in the cell 14. In the honeycomb-like base material 11a, a cell flow passage 15 is formed in a portion (typically, a center portion) in a cross section of the cell 14 in which the acid gas adsorption material layer 16 is not formed. The acid gas adsorption material layer 16 may be formed on the entire inner surface of the partition wall 13 (specifically, so as to surround the cell flow passage 15) as in the illustrated example, or may be formed on part of the surface of the partition wall. When the acid gas adsorption material layer 16 is formed on the entire inner surface of the partition wall 13, an improvement in acid gas (typically, CO₂) adsorption efficiency can be achieved.

The cell flow passage 15 extends from the first end surface E1 (inflow end surface) to the second end surface E2 (outflow end surface) as with the cells 14. Examples of the sectional shape of the cell flow passage 15 include the same sectional shapes as those of the cells 14 described above. Of those, for example, a hexagon or a quadrangle is preferred, and a square, a rectangle, or a hexagon is more preferred. The sectional shapes and sizes of the cell flow passage 15 may be all the same, or may be at least partly different.

The gas to be treated containing the acid gas is typically supplied to the cells 14 (more specifically, the cell flow passages 15) in an adsorption step described later, and the heating medium flows through the cells 14 in the desorption step described later.

The acid gas adsorption material layer 16 includes the acid gas adsorption material in accordance with the acid gas to be adsorbed. When the acid gas is CO₂, the acid gas adsorption material layer 16 includes the above-mentioned carbon dioxide adsorption material.

The acid gas adsorption material layer may be formed only of the acid gas adsorption material. In this case, the acid gas adsorption material is directly supported by the partition wall 13 to face the flow passage. When the acid gas adsorption material layer is formed only of the acid gas adsorption material, the content ratio of the acid gas adsorption material in the acid gas adsorption material layer is typically 95.0 mass % or more and 100 mass % or less. When the content ratio of the acid gas adsorption material falls within the above-mentioned range, excellent acid gas adsorption efficiency can be stably ensured.

In one embodiment, the acid gas adsorption material layer 16 includes a porous carrier in addition to the above-mentioned acid gas adsorption material. In this case, the acid gas adsorption material is typically supported by the porous carrier to face the flow passage. When the acid gas adsorption material layer includes the porous carrier, the escape of the acid gas adsorption material from the acid gas adsorption material layer can be prevented in the adsorption step and/or the desorption step.

The porous carrier may form mesopores in the acid gas adsorption material layer. Examples of the porous carrier include: metal organic frameworks (MOF), such as MOF-74, MOF-200, and MOF-210; activated carbon; nitrogen-doped carbon; mesoporous silica; mesoporous alumina; zeolite; a carbon nanotube; and a fluorinated resin such as polyvinylidene fluoride (PVDF). Of those, for example, metal organic frameworks (MOF), activated carbon, PVDF, zeolite, mesoporous silica, and mesoporous alumina are preferred. Those porous carriers may be used alone or in combination thereof. A material different from that of the acid gas absorption material is preferably adopted for the porous carrier.

The BET specific surface area of the porous carrier is, for example, 50 m²/g or more, preferably 500 m²/g or more. When the surface area of the porous carrier is equal to or more than the above-mentioned lower limits, the acid gas adsorption material can be stably supported, and hence an improvement in acid gas adsorption efficiency can be achieved. The upper limit of the BET specific surface area of the porous carrier is typically 2,000 m²/g.

When the acid gas adsorption material layer includes the acid gas adsorption material and the porous carrier, the content ratio of the total of the acid gas adsorption material and the porous carrier in the acid gas adsorption material layer is, for example, 30 mass % or more, preferably 50 mass % or more. Meanwhile, the content ratio of the total of the acid gas adsorption material and the porous carrier is, for example, 100 mass % or less, preferably 99 mass % or less.

The content ratio of the acid gas adsorption material in the acid gas adsorption material layer is, for example, 30 mass % or more, preferably 50 mass % or more. Meanwhile, the content ratio of the acid gas adsorption material in the acid gas adsorption material layer is, for example, 99 mass % or less. The content ratio of the porous carrier is, for example, 0.01 part by mass or more, preferably 0.3 part by mass or more with respect to 1 part by mass of the acid gas adsorption material. Meanwhile, the content ratio of the porous carrier is, for example, 0.7 part by mass or less, preferably 0.5 part by mass or less with respect to 1 part by mass of the acid gas adsorption material. When the content ratio of the porous carrier falls within the above-mentioned ranges, the acid gas adsorption material can be more stably supported.

Such an acid gas adsorption material layer is typically produced by the following method. A solution of the acid gas adsorption material is prepared by dissolving the above-mentioned acid gas adsorption material in a solvent. Further, the above-mentioned porous carrier is added to the solvent as required. The order of addition of the acid gas adsorption material and the porous carrier is not limited to any particular order. After that, the solution of the acid gas adsorption material is applied onto the base material (specifically, the partition walls), and the coating film is then dried, and is sintered as required. Thus, the acid gas adsorption material layer is formed.

### C. Acid Gas Capture Method

Next, an acid gas capture method according to another aspect of the present disclosure is described with reference to FIG. 1A. The acid gas capture method typically includes an adsorption step and a desorption step in the stated order.

In the adsorption step, a gas to be treated is supplied to the acid gas adsorption part 1 positioned in the flow passage 21 of the housing part 2 to cause the acid gas adsorption material to adsorb an acid gas. In the illustrated example, the first valve 51 and the second valve 52 are set to be in an opened state, and the gas to be treated containing the acid gas is supplied to the flow passage 21 of the housing part 2 through the first inflow port 22. In this case, the gas to be treated containing the acid gas passes through the acid gas adsorption part 1. As a result, the acid gas adsorption material included in the acid gas adsorption part 1 adsorbs the acid gas (typically, CO₂) to separate the acid gas from the gas to be treated.

A temperature (adsorption temperature) of the acid gas adsorption part in the adsorption step is, for example, 0° C. or more, preferably 10° C. or more. Meanwhile, the adsorption temperature is, for example, 50° C. or less, preferably 40° C. or less. In one embodiment, the adsorption temperature is equal to an outside air temperature. An operation time period of the adsorption step (adsorption time) is, for example, 15 minutes or more, preferably 30 minutes or more. Meanwhile, the adsorption time is, for example, 3 hours or less, preferably 2 hours or less.

When the adsorption temperature and/or the adsorption time falls within the above-mentioned ranges, the adsorption gas adsorption material can efficiently adsorb the acid gas.

An acid gas adsorption rate in the adsorption step (=100−(concentration of the acid gas in the treated gas having passed through the acid gas adsorption part/concentration of the acid gas in the gas to be treated before being supplied to the acid gas adsorption part×100)) is, for example, 60% or more, preferably 75% or more, more preferably 80% or more. The upper limit of the acid gas adsorption rate is typically 90%.

Next, as required, the first valve 51 is set to be in a closed state, and the second valve 52 is maintained in an opened state. Under this condition, the pressurizing device 62 is driven to start the supply of the heating medium to the flow passage 21. As a result, the gas to be treated in the flow passage 21 is replaced by the heating medium.

After that, the desorption step is performed. In the desorption step, the heating medium having a pressure above the atmospheric pressure is supplied to the flow passage 21 to heat the acid gas adsorption part 1 to a predetermined desorption temperature, to thereby cause the acid gas adsorption material to desorb the acid gas. In the illustrated example, the first valve 51 and the second valve 52 are set to be in a closed state, and then the pressurizing device 62 and the heating device 63 are driven.

The pressurizing device 62 pumps the heating medium to the heating device 63 through the connection line 64. As a result, the pressurized heating medium is supplied to the heating device 63.

The heating device 63 heats the supplied heating medium. The heating temperature may be suitably and appropriately adjusted in accordance with the heating medium. The heating temperature is a temperature at which the acid gas adsorption part can be adjusted to a range of a desorption temperature described later, and is, for example, equal to or more than the desorption temperature. The heating temperature is more specifically from 70° C. to 160° C., preferably from 80° C. to 160° C. As a result, the acid gas can be efficiently desorbed from the acid gas adsorption material.

After that, the pressurized and heated heating medium passes through the supply line 61 to be supplied to the housing space S. Thus, the temperature of the acid gas adsorption part 1 is increased to a predetermined desorption temperature and the housing space S is increased in pressure.

The flow velocity of the heating medium supplied to the housing space S is, for example, from 0.1 m/s to 8 m/s. The heating medium typically passes through the second inflow port at such a flow velocity to be supplied to the housing space S. Then, in the desorption step, the temperature difference specific heat coefficient (described later) of the heating medium can be suitably adjusted.

The desorption temperature is, for example, 70° C. or more, preferably 80° C. or more. With this configuration, the acid gas can be efficiently desorbed from the acid gas adsorption material. Meanwhile, the desorption temperature is, for example, 160° C. or less, preferably 110° C. or less. With this configuration, the deterioration of the acid gas adsorption material can be stably suppressed. The desorption temperature can be checked by measuring the temperature in the vicinity of the outlet (downstream end) of the acid gas adsorption part.

When the acid gas adsorption part reaches the desorption temperature, the pressure of the housing space S is, for example, 0.12 MPaA or more, preferably 0.16 MPaA or more. With this configuration, the heating efficiency of the acid gas adsorption part can be stably improved. Meanwhile, the pressure of the housing space S is, for example, 1.0 MPaA or less, preferably 0.7 MPaA or less. With this configuration, the plate thickness of each member of the housing part can be suppressed, and a decrease in heating efficiency due to an increase in heat capacity of the housing part can be suppressed.

The operation time period of the desorption step (specifically, the time period during which the acid gas adsorption part is maintained at the above-mentioned desorption temperature and the housing space is maintained at the above-mentioned pressure) is, for example, 1 minute or more, preferably 5 minutes or more. Meanwhile, the operation time period of the desorption step is, for example, 1 hour or less, preferably 30 minutes or less.

In such a desorption step, the acid gas adsorbed by the acid gas adsorption material in the adsorption step is desorbed from the acid gas adsorption material. Thus, the captured gas containing the heating medium having passed through the acid gas adsorption part 1 and the acid gas desorbed from the acid gas adsorption material flows out of the housing part 2 through the second outflow port 25.

In one embodiment, in the desorption step, the temperature difference specific heat coefficient ΔCp/ΔT of the heating medium satisfies the following formula (1). In other words, the acid gas capture system 100 is configured so that the ΔCp/ΔT of the heating medium satisfies the following formula (1). More specifically, under a state in which the acid gas adsorption part 1 is maintained at the above-mentioned desorption temperature and the housing space S is maintained at the above-mentioned pressure, the temperature difference specific heat coefficient ΔCp/ΔT of the heating medium satisfies the following formula (1).

In the embodiment of the present disclosure, the acid gas adsorption part can be efficiently heated by setting the ΔCp/ΔT (also referred to as “temperature difference specific heat coefficient”) in the above-mentioned range. More specifically, it is assumed that heat transfer from the gas easily occurs on an upstream side of the acid gas adsorption part and heating does not easily occur on a downstream side thereof. However, in the embodiment of the present disclosure, a decrease in temperature of the gas in association with the flow is suppressed, and hence the entire acid gas adsorption part can be efficiently heated. Thus, the energy required for heating the acid gas adsorption part can be significantly suppressed, and hence the acid gas capture system can be stably operated with less energy.

$$Δ Cp / Δ T \leq 0.039 ( J / ( mol \cdot {K}^{2} ) ) \qquad ( 1 )$$

ΔCp: a difference between a constant pressure molar specific heat “a” of the supplied heating medium at an inlet of the flow passage 21 and a constant pressure molar specific heat “b” of the captured gas discharged from the flow passage 21 (constant pressure molar specific heat “a”−constant pressure molar specific heat “b”) (unit: J/(mol·K)),
ΔT: a difference between a temperature “a” of the supplied heating medium at the inlet of the flow passage 21 and a temperature “b” of the captured gas discharged from the flow passage 21 (gas temperature “a”−gas temperature “b”) (unit: K).

The ΔCp/ΔT is preferably 0.038 J/(mol·K²) or less. The lower limit of the ΔCp/ΔT is typically −1.1 J/(mol·K²). When the ΔCp/ΔT falls within such a range, the energy required for heating the acid gas adsorption part can be further reduced.

The ΔCp (constant pressure molar specific heat “a”−constant pressure molar specific heat “b”) is, for example, from −2.49 to 3.29, preferably from −2.49 to 1.14.

The constant pressure molar specific heat “a” of the heating medium at the inlet of the flow passage 21 can be calculated by measuring the temperature and pressure in the vicinity of an inlet (upstream end) of the acid gas adsorption part 1. When the heating medium is a mixed gas, the composition of the mixed gas in the vicinity of the inlet of the acid gas adsorption part 1 is measured, and the sum of the composition ratio of each gas multiplied by the constant pressure molar specific heat of the corresponding gas is defined as the constant pressure molar specific heat “a”.

In addition, the constant pressure molar specific heat “b” of the captured gas discharged from the flow passage 21 can be calculated by measuring the temperature and pressure in the vicinity of an outlet (downstream end) of the acid gas adsorption part 1. When the captured gas is a mixed gas, the composition of the mixed gas in the vicinity of the outlet of the acid gas adsorption part 1 is measured, and the sum of the composition ratio of each gas multiplied by the constant pressure molar specific heat of the corresponding gas is defined as the constant pressure molar specific heat “b”.

The range of the temperature “a” of the heating medium (heating medium at the time of passage through the second inflow port) supplied to the flow passage 21 is the same as the range of the heating temperature in the above-mentioned heating device.

After that, the captured gas having passed through the second outflow port 25 is supplied to the storage tank 42 through the capture line 41 and stored in the storage tank 42.

The internal pressure of the storage tank 42 is, for example, from 0.12 MPaA to 1.0 MPaA, preferably from 0.16 MPaA to 0.7 MPaA.

Thus, the captured gas stored in the storage tank 42 can be smoothly supplied to another device when being utilized for various applications (for example, a raw material for synthetic fuel). In addition, as described above, at least part of the captured gas can be returned as the heating medium to the heating medium supply part 6 by the return part 3. When the internal pressure of the storage tank falls within the above-mentioned ranges, at least part of the captured gas can be utilized as the heating medium without additional pressure adjustment, and hence the energy required for pressurization can be further reduced.

The acid gas capture method may include a cooling step in addition to the adsorption step and the desorption step. The cooling step is performed after the desorption step and before the adsorption step, and the acid gas adsorption part is cooled to the above-mentioned adsorption temperature. The adsorption step, the desorption step, and the cooling step are preferably continuously performed repeatedly in the stated order.

### EXAMPLES

Now, the present disclosure is specifically described by way of Examples. However, the present disclosure is not limited to these Examples.

### Example 1

The acid gas capture system illustrated in FIG. 1A was prepared. The acid gas capture system included the above-mentioned acid gas adsorption part, the above-mentioned housing part, the above-mentioned heating medium supply part, and the above-mentioned capture part. As illustrated in FIG. 3 and FIG. 4, the acid gas adsorption part included the above-mentioned honeycomb-like base material and the above-mentioned acid gas adsorption material layer.

Next, the above-mentioned adsorption step and the above-mentioned desorption step were performed in the stated order by the acid gas capture system.

In the desorption step, the pressure of the housing space that houses the acid gas adsorption part was maintained at 0.16 MPa in the housing part. In this state, the heating medium supply part supplied carbon dioxide serving as a heating medium to the flow passage of the housing part through the second inflow port. In this case, the captured gas containing the carbon dioxide having passed through the acid gas adsorption part and the carbon dioxide desorbed from the acid gas adsorption material was discharged from the housing part through the second outflow port.

The pressure and temperature (supply temperature “a”) of the heating medium passing through the second inflow port, the temperature (discharge temperature “b”) of the captured gas passing through the second outflow port, the temperature difference ΔT therebetween, and ΔCp/ΔT are shown in Table 1.

As a result, the temperature difference in the acid gas adsorption part was maintained within 10° C. in the desorption step.

### Examples 2 and 3

The desorption step was performed in the same manner as in Example 1 except that the supply temperature “a” was changed to a value shown in Table 1. In the desorption step, the temperature difference in the acid gas adsorption part was maintained within the ΔT shown in Table 1.

### Examples 4 to 6

The desorption step was performed in the same manner as in Examples 1 to 3 except that the pressure of the heating medium passing through the second inflow port was changed to 0.210 MPa. In the desorption step, the temperature difference in the acid gas adsorption part was maintained within the ΔT shown in Table 1.

### Comparative Example 1

The desorption step was performed in the same manner as in Example 1 except that the heating medium supply part supplied carbon dioxide at the atmospheric pressure (0.101 MPaA) as the heating medium to the flow passage of the housing part. In the desorption step, the temperature difference in the acid gas adsorption part was maintained within 1° C.

TABLE 1

| | | Supply | Discharge | ΔT | |
|---|---|---|---|---|---|
| | | temperature | temperature | (=“a” − | ΔCp/ΔT |
| | Pressure | “a” | “b” | “b”) | [J/(mol · |
| No. | [MPaA] | [ ° C.] | [ ° C.] | [ ° C.] | K²)] |
| Example 1 | 0.160 | 120 | 110 | 10 | 0.036 |
| Example 2 | | 90 | 85 | 5 | 0.038 |
| Example 3 | | 80 | 79 | 1 | 0.038 |
| Example 4 | 0.210 | 120 | 110 | 10 | 0.035 |
| Example 5 | | 90 | 85 | 5 | 0.037 |
| Example 6 | | 80 | 79 | 1 | 0.037 |
| Compar- | 0.101 | 71 | 70 | 1 | 0.040 |
| ative | | | | | |
| Example 1 | | | | | |

### Evaluation

As is apparent from Table 1, in Examples 1 to 6 in which the heating medium having a pressure above the atmospheric pressure is supplied to the flow passage in the desorption step, the ΔCp/ΔT can be stably set to 0.039 (J/(mol·K²)) or less, and in Comparative Example 1 in which the heating medium at the atmospheric pressure is supplied to the flow passage, the ΔCp/ΔT can be 0.040 (J/(mol·K²)). Thus, it is understood that, in Examples 1 to 6, the acid gas adsorption part can be sufficiently heated with less energy as compared to Comparative Example 1.

In particular, in Example 3, the pressure of the heating medium is lower than those of Examples 4 to 6, and the supply temperature of the heating medium is lower than those of Examples 1, 2, 4, and 5. Thus, the energy required for heating the acid gas adsorption part is the smallest. However, in Example 3, the ΔCp/ΔT is 0.039 (J/(mol·K²)) or less, and hence the acid gas adsorption part can be sufficiently heated with less energy in the desorption step.

The acid gas capture system and the acid gas capture method according to the embodiment of the present disclosure can be used for separation and capture of an acid gas, and particularly, can be suitably used for a Carbon dioxide Capture, Utilization and Storage (CCUS) cycle.

What is claimed is:

1. An acid gas capture system, comprising:
an acid gas adsorption part including an acid gas adsorption material capable of adsorbing an acid gas contained in a gas to be treated and capable of desorbing the adsorbed acid gas;
a housing part, which includes a flow passage to which the gas to be treated is to be supplied, and which is configured to house the acid gas adsorption part so that the acid gas adsorption part is positioned in the flow passage;
a heating medium supply part configured to supply a heating medium having a pressure above an atmospheric pressure to the flow passage; and
a capture part configured to capture a captured gas containing the heating medium having passed through the acid gas adsorption part and the acid gas desorbed from the acid gas adsorption material, from the housing part.

2. The acid gas capture system according to claim 1, wherein a temperature difference specific heat coefficient ΔCp/ΔT of the heating medium is set so as to satisfy the following formula (1):
$$Δ Cp / Δ T \leq 0.039 ( J / ( mol \cdot {K}^{2} ) ) \qquad ( 1 )$$
ΔCp: a difference between a constant pressure molar specific heat “a” of the supplied heating medium at an inlet of the flow passage and a constant pressure molar specific heat “b” of the captured gas discharged from the flow passage (constant pressure molar specific heat “a”−constant pressure molar specific heat “b”) (unit: J/(mol·K)),
ΔT: a difference between a temperature “a” of the supplied heating medium at the inlet of the flow passage and a temperature “b” of the captured gas discharged from the flow passage (gas temperature “a”−gas temperature “b”) (unit: K).

3. The acid gas capture system according to claim 1, wherein the heating medium supply part includes a pressurizing device configured to pressurize the heating medium.

4. The acid gas capture system according to claim 1, wherein the capture part includes a storage tank configured to store the captured gas.

5. The acid gas capture system according to claim 4, further comprising a return part configured to return at least part of the captured gas stored in the storage tank, as the heating medium from the storage tank to the heating medium supply part.

6. The acid gas capture system according to claim 4, wherein the storage tank is configured to separate part of the heating medium from the captured gas.

7. The acid gas capture system according to claim 1, wherein the acid gas is carbon dioxide.

8. An acid gas capture method, comprising:
an adsorption step of supplying a gas to be treated containing an acid gas, to a flow passage of a housing part in which an acid gas adsorption part including an acid gas adsorption material is arranged, to cause the acid gas adsorption material to adsorb the acid gas; and
a desorption step of supplying a heating medium having a pressure above an atmospheric pressure to the flow passage, and heating the acid gas adsorption part to a predetermined desorption temperature to cause the acid gas adsorption material to desorb the acid gas,
wherein, in the desorption step, a captured gas containing the heating medium having passed through the acid gas adsorption part and the acid gas desorbed from the acid gas adsorption material is discharged from the flow passage.

9. The acid gas capture method according to claim 8, wherein a temperature difference specific heat coefficient ΔCp/ΔT of the heating medium satisfies the following formula (1):
$$Δ Cp / Δ T \leq 0.039 ( J / ( mol \cdot {K}^{2} ) ) \qquad ( 1 )$$
ΔCp: a difference between a constant pressure molar specific heat “a” of the supplied heating medium at an inlet of the flow passage and a constant pressure molar specific heat “b” of the captured gas discharged from the flow passage (constant pressure molar specific heat “a”−constant pressure molar specific heat “b”) (unit: J/(mol·K)),
ΔT: a difference between a temperature “a” of the supplied heating medium at the inlet of the flow passage and a temperature “b” of the captured gas discharged from the flow passage (gas temperature “a”−gas temperature “b”) (unit: K).
